(19) United States
(12) Patent Application Publication
(10) Pub. No.: US 2026/0313706 A1
(43) Pub. Date: Oct. 8, 2026

(54) METHOD AND APPARATUS FOR OPTIMIZING RANDOM ACCESS IN A WIRELESS COMMUNICATION SYSTEM

(71) Applicant: SAMSUNG ELECTRONICS CO., LTD., Suwon-si, Gyeonggi-do (KR)

(72) Inventor: Aby Kanneath ABRAHAM, Bangalore (IN)

(21) Appl. No.: 19/490,325

(22) PCT Filed: Jun. 5, 2024
(86) PCT No.: PCT/KR2024/007689

§ 371 Date: Dec. 4, 2025

(30) Foreign Application Priority Data
Jun. 6, 2023 (IN) 202341038874
May 15, 2024 (IN) 202341038874

(51) Int. Cl. H04W 74/0833

(52) U.S. Cl. CPC H04W 74/0833

(57) ABSTRACT

The disclosure relates to a 5G or 6G communication system for supporting a higher data transmission rate. Embodiments herein provide a method and network apparatus (200) for optimizing a RA of a UE (100) in a wireless communication network, the method comprises receiving, from a network entity, an information request message, setting information on a random access (RA) procedure and transmitting, to the network entity, an information response message including the information on the RA procedure, wherein the information on the RA procedure includes information on a feature triggering the RA procedure.

### TECHNICAL FIELD

The disclosure relates to the field of wireless communication network. More particularly the disclosure relates to optimizing a random access of a user equipment in a wireless communication network system.

### BACKGROUND ART

5G mobile communication technologies define broad frequency bands such that high transmission rates and new services are possible, and can be implemented not only in “Sub 6 GHz” bands such as 3.5 GHZ, but also in “Above 6 GHz” bands referred to as mmWave including 28 GHz and 39 GHz. In addition, it has been considered to implement 6G mobile communication technologies (referred to as Beyond 5G systems) in terahertz (THz) bands (for example, 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive MIMO for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of BWP (BandWidth Part), new channel coding methods such as a LDPC (Low Density Parity Check) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as V2X (Vehicle-to-everything) for aiding driving determination by autonomous vehicles based on information regarding positions and states of vehicles transmitted by the vehicles and for enhancing user convenience, NR-U (New Radio Unlicensed) aimed at system operations conforming to various regulation-related requirements in unlicensed bands, NR UE Power Saving, Non-Terrestrial Network (NTN) which is UE-satellite direct communication for providing coverage in an area in which communication with terrestrial networks is unavailable, and positioning.

Moreover, there has been ongoing standardization in air interface architecture/protocol regarding technologies such as Industrial Internet of Things (IIoT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with eXtended Reality (XR) for efficiently supporting AR (Augmented Reality), VR (Virtual Reality), MR (Mixed Reality) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using OAM (Orbital Angular Momentum), and RIS (Reconfigurable Intelligent Surface), but also full-duplex technology for increasing frequency efficiency of 6G mobile communication technologies and improving system networks, AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultra-high-performance communication and computing resources.

### DISCLOSURE OF INVENTION

### Solution to Problem

The principal object of the disclosure is optimizing a RA of a UE in a wireless communication network system.

Another object of the disclosure is that the UE informs a network that the RA is triggered by the feature msg1 repetition.

Another object of the disclosure is that UE informs the network that the RA is performed by using the RA resources or the RA configuration for the feature msg1 repetition.

Another object of the disclosure is that the UE reports the triggered feature combination or used feature combination including msg1 repetition.

Another object of the disclosure is that UE reports the number of repetitions configured by the network and the number of repetitions performed by the UE.

Another object of the disclosure is that UE reports the beam related information for the msg1 repetitions.

Another object of the disclosure is to provide network methods for optimizing the RA when msg1 repetitions is configured.

A further object of the disclosure is to provide method by which the UE reports dl RSRP Above Threshold with the msg1 repetitions, etc.

In one aspect, the embodiments herein are achieved by providing a method for optimizing a RA of a UE in a wireless communication network system. The method includes performing, by the UE, the RA with a network apparatus associated with the UE by applying message1 (msg1) repetitions. Applying msg1 repetitions, in this scope of the invention includes the scenarios where the UE performed random access using the resources or configurations associated to the feature msg1 repetitions and also the scenarios where the random access is triggered for msg1 repetitions but the UE performed random access without using the resources or configurations associated to the feature msg1 repetitions. Further, the method includes storing, by the UE, RA-information in a memory of the UE. The RA-information includes a plurality of resources indicating the RA triggered by the msg1 repetitions or the RA has used the msg1 repetitions. Further, the method includes transmitting, by the UE, the stored RA-information to the network apparatus for optimizing the RA for the UE.

In an embodiment, the plurality of resources includes an information that the random access is triggered due to a feature msg1 repetitions or that msg1 repetitions is one of the features that triggered RA.

In an embodiment, the plurality of resources includes an information that the resources or parameters for the RA were selected using the feature msg1 repetitions or that msg1 repetitions is one of the features that is used for selecting RA resources.

In an embodiment, the plurality of resources includes the msg1 repetitions are performed, a number of msg1 repetitions performed, a RSRP threshold used for selecting the number of msg1 repetitions, a Downlink Received signal Received Power (DLRSRP) above or below a msg1 repetitions threshold, a triggered feature combination including the msg1 repetitions, a feature combination including the msg1 repetitions, a number of the msg1 repetitions configured by the network, and a beam related information for the msg1 repetitions.

In an embodiment, transmitting, by the UE, the stored RA information to the network apparatus for optimizing the RA for the UE includes receiving, by the UE, an information request message from the network apparatus. Further the method includes creating, by the UE, an information response message comprising the RA-information stored by the UE. Further the method includes transmitting, by the UE, the information response message comprising the RA-information to the network apparatus for optimizing the RA for the UE.

In an embodiment, the information request message comprises indication of at least one of a connection failure report request, a RA-report request, an RLF-report (Radio Link Failure report) request, a CEF-report (Connection EstablishmentFailure report) request, and a SHR (Successful Handover Report) request, SPR (Successful PSCell change or addition report) request and wherein the information response message comprises a connection failure report, a RA-report, a RLF report, a CEF report, a SHR and a SPR.

In another aspect, the embodiment herein provides the method for optimizing RA of the UE in the wireless communication network system. The method includes transmitting by the network apparatus, the information request message to the UE. Further the method includes receiving, by the network apparatus, the information response message from the UE. The information response message comprises RA-information stored by the UE. The RA-information includes the plurality of resources indicating one of the RA triggered by the msg1 repetitions or the RA has used the msg1 repetitions. Further the method includes optimizing, by the network apparatus, the plurality of resources based on the RA-information. Further the method includes optimizing, by the network apparatus, the plurality of resources based on the RA-information comprises determining, by the network apparatus, whether a number of resources allocated to perform msg1 repetitions a specific feature is optimum based on the RA-information. Further the method includes modifying, by the network apparatus, the number of resources allocated to perform the msg1 repetitions based on the RA-information when the number of resources allocated to perform the msg1 repetitions is not optimum.

In an embodiment, the plurality of resources includes the msg1 repetitions are performed, the number of msg1 repetitions performed, the RSRP threshold used for selecting the number of msg1 repetitions, the DLRSRP above or below the msg1 repetitions threshold, the triggered feature combination including the msg1 repetitions, the feature combination including the msg1 repetitions, the number of the msg1 repetitions configured by the network, and the beam related information for the msg1 repetitions.

In an embodiment, the information request message comprises indication of at least one of the connection failure report requests, the RA-report request (such as NR Information Element (IE) ra-ReportReq-r16), the RLF-report request (such as NR Information Element (IE) rlf-ReportReq-r16), the CEF-report request (such as NR Information Element (IE) connEstFailReportReq-r16), the SHR request (such as NR Information Element (IE) successHO-ReportReq-r17) and the SPR request (such as NR Information Element (IE) successPSCell-ReportReq-r18), and the information response message comprises the connection failure report (such as NR Information Element (IE) ra-ReportReq-r16), the RA-report (such as NR Information Element (IE) ra-ReportList-r16), the RLF report (such as NR Information Element (IE) rlf-Report-r16), the CEF report (such as NR Information Element (IE) connEstFailReport-r16 or connEstFailReportList-r17), the SHR (such as NR Information Element (IE) successHO-Report-r17) and the SPR (such as NR Information Element (IE) successPSCell-Report-r18).

In another aspect, the embodiment herein provides the UE for optimizing the RA of the UE in the wireless communication network system. The UE includes the memory comprising information of the Network Apparatus in the wireless communication network system a processor, a communicator and a msg1 repetitions controller, connected to the memory and the processor, the msg1 repetitions controller. The msg1 repetition controller performs the RA with the network apparatus associated with the UE by applying msg1 repetitions. Further the method stores RA-information in the memory of the UE. The RA-information comprises the plurality of resources indicating the RA triggered by the msg1 repetitions or the RA has used the msg1 repetitions. Further the method transmits the stored RA-information to the network apparatus for optimizing the RA for the UE.

In another aspect, the embodiment herein provides the Network Apparatus for optimizing the RA of the UE in the wireless communication network system. The network apparatus includes a memory comprising information of a Network Apparatus in the wireless communication network system, a memory, a processor, a communicator and a msg1 repetitions controller, connected to the memory and the processor. The msg1 repetitions controller transmits an information request message to the UE. Further msg1 repetitions controller receives an information response message from the UE. The information response message comprises RA-information stored by the UE. The RA-information comprises the plurality of resources indicating one of the RA triggered by the msg1 repetitions or the RA has used the msg1 repetitions and optimize the polarity of resources based on the RA-information.

These and other aspects of the embodiments herein will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications be made within the scope of the embodiments herein.

### Advantageous Effects of Invention

Aspects of the disclosure are to address at least the above-mentioned problems and/or disadvantages and to provide at least the advantages described below. Accordingly, an aspect of the disclosure is to provide efficient communication methods in a wireless communication system.

### BRIEF DESCRIPTION OF DRAWINGS

These and other features, aspects, and advantages of the embodiments are illustrated in the accompanying drawings, throughout which like reference letters indicate corresponding parts in the various figures. The embodiments herein will be better understood from the following description with reference to the drawings.

FIG. 1 illustrates a block diagram of a UE that illustrates various hardware components used for optimizing a RA in a wireless communication network system, according to the embodiments disclosed herein.

FIG. 2 illustrates a block diagram of a network apparatus that illustrates various hardware components for optimizing the RA the wireless communication network system, according to the embodiments disclosed herein.

FIG. 3 is a flow chart that illustrates a method for LBT and msg11 repetitions, according to the embodiments as disclosed herein.

FIG. 4 is a sequence diagram that illustrates reporting msg1 repetitions information to the network apparatus, according to the embodiments as disclosed herein.

FIG. 5 is a flow chart that illustrates a method implemented by the network apparatus for optimizing the RA in the wireless communication network system, according to the embodiments as disclosed herein.

FIG. 6 is a flow chart that illustrates a method implemented by the UE for storing, reporting and optimizing the RA in the wireless communication network system, according to embodiments disclosed herein.

FIG. 7 illustrates a block diagram of a user equipment that illustrates various hardware components.

FIG. 8 illustrates a block diagram of a network entity that illustrates various hardware components.

It may be noted that to the extent possible, like reference numerals have been used to represent like elements in the drawing. Further, those of ordinary skill in the art will appreciate that elements in the drawing are illustrated for simplicity and may not have been necessarily drawn to scale. For example, the dimension of some of the elements in the drawing may be exaggerated relative to other elements to help to improve the understanding of aspects of the invention. Furthermore, the elements may have been represented in the drawing by conventional symbols, and the drawings may show only those specific details that are pertinent to the understanding the embodiments of the invention so as not to obscure the drawing with details that will be readily apparent to those of ordinary skill in the art having benefit of the description herein.

### BEST MODE FOR CARRYING OUT THE INVENTION

Aspects of the disclosure are to address at least the above-mentioned problems and/or disadvantages and to provide at least the advantages described below. Accordingly, an aspect of the disclosure is to provide a terminal and a communication method thereof in a wireless communication system.

### MODE FOR THE INVENTION

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. Also, the various embodiments described herein are not necessarily mutually exclusive, as some embodiments can be combined with one or more other embodiments to form new embodiments. The term “or” as used herein, refers to a non-exclusive or, unless otherwise indicated. The examples used herein are intended merely to facilitate an understanding of ways in which the embodiments herein can be practiced and to further enable those skilled in the art to practice the embodiments herein. Accordingly, the examples are not be construed as limiting the scope of the embodiments herein.

As is traditional in the field, embodiments are described and illustrated in terms of blocks that carry out a described function or functions. These blocks, which referred to herein as managers, units, modules, hardware components or the like, are physically implemented by analog and/or digital circuits such as logic gates, integrated circuits, microprocessors, microcontrollers, memory circuits, passive electronic components, active electronic components, optical components, hardwired circuits and the like, and optionally be driven by firmware and software. The circuits, for example, be embodied in one or more semiconductor chips, or on substrate supports such as printed circuit boards and the like. The circuits constituting a block be implemented by dedicated hardware, or by a processor (e.g., one or more programmed microprocessors and associated circuitry), or by a combination of dedicated hardware to perform some functions of the block and a processor to perform other functions of the block. Each block of the embodiments be physically separated into two or more interacting and discrete blocks without departing from the scope of the proposed method. Likewise, the blocks of the embodiments be physically combined into more complex blocks without departing from the scope of the proposed method.

The accompanying drawings are used to help easily understand various technical features and it is understood that the embodiments presented herein are not limited by the accompanying drawings. As such, the proposed method is construed to extend to any alterations, equivalents and substitutes in addition to those which are particularly set out in the accompanying drawings. Although the terms first, second, etc. used herein to describe various elements, these elements are not be limited by these terms. These terms are generally used to distinguish one element from another.

Generally, in Random Access Channel (RACH) the 5th Generation (5G) wireless communication system, Random Access (RA) is supported. The RA is used to achieve an uplink (UL) time synchronization. The RA is used during initial access, handover, radio resource control (RRC) connection re-establishment procedure, scheduling request transmission, secondary cell group (SCG) addition/modification, beam failure recovery, data or control information transmission in the UL by non-synchronized a User-Equipment (UE) in a RRC connected state etc. Several types of RA procedure are supported.

In Contention-based Random Access (CBRA), the UE first transmits a RA preamble (also referred as Msg1) and then waits for a Random-Access Response (RAR) in a RAR window (also referred as Msg2). A network node such as a Next generation node B (gNB) transmits the RAR on a physical downlink shared channel (PDSCH). The Physical Downlink Control Channel (PDCCH) scheduling the PDSCH carrying the RAR is addressed to a RA-Radio Network Temporary Identifier (RA-RNTI). The RA-RNTI identifies the time-frequency resource (also referred as a physical RA channel (PRACH) occasion or a PRACH transmission (TX) occasion or a RA channel (RACH) occasion) in which the RA preamble was detected by the gNB. When the RAR corresponding to its RA preamble transmission is received, the UE transmits message 3 (Msg3) in the UL grant received in the RAR. The Msg3 includes message such as a RRC connection request, a RRC connection re-establishment request, a RRC handover confirm, a scheduling request, a System Information (SI) request etc. It may include the UE identity (i.e. cell-radio network temporary identifier (C-RNTI) or system architecture evolution (SAE)-temporary mobile subscriber identity (S-TMSI) or a random number). The Msg3 includes message such as the RRC connection request, the RRC connection re-establishment request, the RRC handover confirm, the scheduling request, a System Information (SI) request etc. It may include the UE identity (i.e. C-RNTI) or (SAE)-(S-TMSI) or the random number). While the contention resolution timer is running, if the UE receives contention resolution MAC control element (CE) including the UE's contention resolution identity (first X bits of common control channel (CCCH) service data unit (SDU) transmitted in Msg3), the contention resolution is considered successful, the contention resolution timer is stopped and the RA procedure is completed. While the contention resolution timer is running, if the UE receives contention resolution MAC control element (CE) including the UE's contention resolution identity (first X bits of the (CCCH) (SDU) transmitted in Msg3), the contention resolution is considered successful, the contention resolution timer is stopped and the RA procedure is completed. If the contention resolution timer expires and the UE has not yet transmitted the RA preamble for a configurable number of times, the UE goes back to first step i.e. select a random-access resource (preamble/RACH occasion) and transmits the RA preamble. A back off may be applied before going back to first step.

A Contention Free Random Access (CFRA) is also referred as legacy the CFRA or a 4 step CFRA. The CFRA procedure is used for scenarios such as handover where low latency is required, timing advance establishment for secondary cell (Scell), etc. The Network node such as the (gNB) assigns to the UE dedicated RA preamble. The UE transmits the dedicated RA preamble. The gNB transmits the RAR on the PDSCH addressed to the RA-RNTI. The RAR conveys RA preamble identifier and timing alignment information. The RAR may also include the UL grant. The RAR is transmitted in RAR window similar to CBRA) procedure. The CFRA is considered successfully completed after receiving the RAR including a RA Preamble Identifier (RAPID) of the RA preamble transmitted by the UE. In case the RA is initiated for beam failure recovery, the CFRA is considered successfully completed if the PDCCH addressed to the C-RNTI is received in a search space for a beam failure recovery. If the RAR window expires and the RA is not successfully completed and the UE has not yet transmitted the RA preamble for a configurable number of times (configured by the gNB in a RACH configuration), the UE retransmits the RA preamble.

In a first step of a 2-Step (CBRA), the UE transmits RA preamble on the PRACH and a payload (i.e. MAC PDU) on a (Physical Uplink Shared Channel) PUSCH. The RA preamble and the payload transmission is also referred as a MsgA. In the second step, after the MsgA transmission, the UE monitors for a response from the network (i.e. the gNB) within a configured window. The response is also referred as a MsgB. If the CCCH SDU was transmitted in the MsgA payload, the UE performs contention resolution using the contention resolution information in the MsgB. The contention resolution is successful if the contention resolution identity received in the MsgB matches first 48 bits of the CCCH SDU transmitted in the MsgA. If the C-RNTI was transmitted in the MsgA payload, the contention resolution is successful if the UE receives the PDCCH addressed to the C-RNTI. If the contention resolution is successful, the RA procedure is considered successfully completed. Instead of the contention resolution information corresponding to the transmitted MsgA, The MsgB may include a fallback information corresponding to the RA preamble transmitted in the MsgA. If the fallback information is received, the UE transmits the Msg3 and performs contention resolution using Msg4 as in CBRA procedure. If contention resolution is successful, RA procedure is considered successfully completed. If contention resolution fails upon fallback (i.e. upon transmitting the Msg3), the UE retransmits the MsgA. If configured window in which the UE monitor network response after transmitting the MsgA expires and the UE has not received the MsgB including contention resolution information or fallback information as explained above, the UE retransmits the MsgA. If the RA procedure is not successfully completed even after transmitting the msgA configurable number of times, the UE fallbacks to the 4 step RACH procedure i.e. the UE only transmits the PRACH preamble.

In 2 Step CFRA case the gNB assigns to the UE dedicated the RA preamble(s) and the PUSCH resource(s) for the MsgA transmission. The RACH Occasions (RO(s)) to be used for preamble transmission may also be indicated. In the first step, the UE transmits RA preamble on the PRACH and a payload on PUSCH using the CFRA resources (i.e. dedicated the preamble/PUSCH resource/RO). In the second step, after the MsgA transmission, the UE monitors for a response from the network (i.e. the gNB) within a configured window. If the UE receives the PDCCH addressed to the C-RNTI, the RA procedure is considered successfully completed. If the UE receives fallback information corresponding to its transmitted preamble, RA procedure is considered successfully completed.

The RA Enhancements in NR Release 17 enhances the RACH for various features like slicing, small data transmission, reduced capability UEs, coverage enhancements (the msg3 repetitions) etc. A number of preambles from available RACH preambles and a number of RO may be partitioned for various features. The gNB may also allocate different available RACH occasions to different features as indicated in the system information. For slicing, different slices or slice groups may be allocated different RACH resources. For a Small Data Transmission (SDT), there could be separate preamble groups based on the size of data to be transmitted. For coverage enhancements, the UE may be configured to repeat the msg3. For a Reduced Capability (REDCAP), the msg1 resources allocated could be used to identify that the device is a reduced capability device. In addition, for each feature, a number of RACH parameters which can be configured separately.

The Information Element (IE) Feature Combination indicates a feature or a combination of features to be associated with a set of RA resources (i.e. an instance of Feature Combination Preambles).

Table 1 that defines feature groups and its characteristics is given characteristics is given below.

TABLE 1
-- ASN1START
-- TAG-FEATURECOMBINATION-START
FeatureCombination-r17 ::= SEQUENCE {

| | |
|---|---|
| redCap-r17 | ENUMERATED {true} |

OPTIONAL, -- Need R

| | |
|---|---|
| smallData-r17 | ENUMERATED {true} |

OPTIONAL, -- Need R

| | |
|---|---|
| sliceGroup-r17 | SliceGroupList-r17 |

OPTIONAL, -- Need R

| | |
|---|---|
| msg3-Repetitions-r17 | ENUMERATED {true} |

OPTIONAL, -- Need R

| | |
|---|---|
| spare4 | ENUMERATED {true} |

OPTIONAL, -- Need R

| | |
|---|---|
| spare3 | ENUMERATED {true} |

OPTIONAL, -- Need R

| | |
|---|---|
| spare2 | ENUMERATED {true} |

OPTIONAL, -- Need R

| | |
|---|---|
| spare 1 | ENUMERATED {true} |

OPTIONAL -- Need R
}
SliceGroupList-r17 ::= SEQUENCE (SIZE (1..ffsUpperLimit)) OF SliceGroupID-r17
-- TAG-FEATURECOMBINATION-STOP
-- ASN1STOP

The IE Feature Combination Preambles associates a set of preambles with the feature combination. For parameters which can be provided in the IE, the UE applies this field value when performing the RA using the preamble in this feature Combination Preambles, otherwise the UE applies the corresponding value as determined by applicable Need Code, e.g. Need S. On a specific Band Width Part (BWP), there can be at most one set of preambles associated with a given feature combination per the RA Type (i.e. 4-step RACH or 2-step RACH).

Each of the features may be allocated a feature priority. When feature specific RACH partitioning is used, UL BWP configuration can include additional the RACH configuration as below.

The Feature Combination information element is as shown below:

TABLE 2
-- ASN1START
-- TAG-FEATURECOMBINATIONPREAMBLES-START

| | |
|---|---|
| FeatureCombinationPreambles-r17 ::= | SEQUENCE { |
| featureCombination-r17 | FeatureCombination-r17, |
| startPreambleForThisPartition-r17 | INTEGER (1..64), |

numberOfPreamblesPerSSB-ForThisPartition-r17 INTEGER (1..64),

| | |
|---|---|
| ssb-SharedRO-MaskIndex-r17 | INTEGER (1..15) |

OPTIONAL, -- Need S

| | |
|---|---|
| groupBconfigured-r17 | SEQUENCE { |
| ra-SizeGroupA-r17 | ENUMERATED {b56, b144, b208, b256, b282, b480, |

b640,

b800, b1000, b72, spare6,

spare5,spare4, spare3, spare2, spare1},

| | |
|---|---|
| messagePowerOffsetGroupB | ENUMERATED { minusinfinity, dB0, dB5, dB8, |

dB10,
dB12, dB15, dB18},

| | |
|---|---|
| numberOfRA-PreamblesGroupA | INTEGER (1..64) |

}
OPTIONAL, -- Need S

| | |
|---|---|
| separateMsgA-PUSCH-Config-r17 | MsgA-PUSCH-Config-r16 |

OPTIONAL, -- Cond MsgAConfigCommon

| | |
|---|---|
| msgA-RSRP-Threshold-r17 | RSRP-Range |

OPTIONAL, -- Need R

| | |
|---|---|
| rsrp-ThresholdSSB-r17 | RSRP-Range |

OPTIONAL, -- Need R

| | |
|---|---|
| deltaPreamble-r17 | INTEGER (−1..6) |

OPTIONAL, -- Need R
...
}
-- TAG-FEATURECOMBINATIONPREAMBLES-STOP
-- ASN1STOP

| | |
|---|---|
| BWP-UplinkCommon ::= | SEQUENCE { |
| genericParameters | BWP, |
| rach-ConfigCommon | SetupRelease { RACH-ConfigCommon } |

OPTIONAL, -- Need M

| | |
|---|---|
| pusch-ConfigCommon | SetupRelease { PUSCH-ConfigCommon } |

OPTIONAL, -- Need M

| | |
|---|---|
| pucch-ConfigCommon | SetupRelease { PUCCH-ConfigCommon } |

```
  OPTIONAL, -- Need M
        ...,
        [[
```

| | |
|---|---|
| rach-ConfigCommonIAB-r16 | SetupRelease { RACH-ConfigCommon } |

OPTIONAL, -- Need M

| | |
|---|---|
| useInterlacePUCCH-PUSCH-r16 | ENUMERATED {enabled} |

OPTIONAL, -- Need R

| | |
|---|---|
| msgA-ConfigCommon-r16 | SetupRelease { MsgA-ConfigCommon-r16 } |

```
  OPTIONAL -- Cond SpCellOnly2
        ]],
        [[
```

| | |
|---|---|
| enableRA-PrioritizationForSlicing-r17 | BOOLEAN |

OPTIONAL, -- Cond RAPrioSliceAI

| | |
|---|---|
| additionalRACH-ConfigCommon-r17 | SEQUENCE (SIZE(0..maxAdditionalRACH- |

```
  r17)) OF
  AdditionalRACH-ConfigCommon-r17 OPTIONAL -- Cond SpCellOnly3
        ]]
  AdditionalRACH-ConfigCommon-r17 ::= SEQUENCE {
```

| | |
|---|---|
| rach-ConfigCommon-r17 | RACH-ConfigCommon |

OPTIONAL, -- Need R

| | |
|---|---|
| msgA-ConfigCommon-r17 | MsgA-ConfigCommon-r16 |

```
  OPTIONAL, -- Cond R
        ...
  }
```

The RACH performed according to the above may be generally called feature specific RACH. When the applicable feature is slicing, also known as slice specific RACH.

The msg1 repetitions for coverage enhancements: In Release 18, 3gpp is introducing various steps for improving the coverage of a New Radio (NR) networks, especially the PRACH coverage enhancements. One of the methods considered in the 3gpp R18 for coverage enhancement is the msg1 repetitions, i.e. to allow the UE to repeat the msg1. For the multiple PRACH transmissions with same transmission beam, it is possible that the multiple PRACH are transmitted on separate the RO. It is also possible that UE performs msg1 repetition with separate preamble on the shared ROs. Multiple PRACH transmissions within one RACH attempt are only performed within one RO group.

The msg1 repetitions may have one or more of the below properties:
If only one value is configured for the multiple PRACH transmissions, then the number of valid ROs in the RO group is equal to this value.
The number of valid ROs in the RO group is equal to one of the configured numbers(s) of multiple PRACH transmissions.
If multiple values are configured for multiple PRACH transmissions, for each value, the number of valid ROs in the RO group is equal to the corresponding number of multiple PRACH transmissions.
The starting point of the RAR window is after the last symbol of the last valid RO in the RO group corresponding to the multiple PRACH transmissions. The last valid RO is irrespective of whether the PRACH transmission on the last valid RO in the RO group is dropped or not.
The msg1 repetitions can be used for the CBRA.
The msg1 repetitions can be used for the CFRA, for e.g. during a handover.
The Network such as the gNB may configure multiple (Reference Signal Received Power) RSRP thresholds for different repetition numbers, per the (Band Width Parts) BWP and each of these RSRP thresholds correspond to a repetition number for the msg1 repetition.
For all the repetitions of the RA preamble transmission in the msg1 repetition, there may be one the RAR send from network (such as the gNB).
The UE repeats preamble transmissions (i.e. repeats the MSG1) without waiting for the RAR and receives a single RAR in the RAR window.

The NR operations in the unlicensed spectrum, the gNB and the UE applies a Listen-Before-Talk (LBT) before performing a transmission on a cell configured with shared spectrum channel access (unlicensed spectrum). When the LBT is applied, the transmitter listens to/senses the channel to determine whether the channel is free or busy and performs transmission only if the channel is sensed free.

The self-optimization in the NR, a 5G NR radio access network also known as NG-RAN (Next Generation Radio Network) comprises of a number of NR base stations knows as the gNBs. The gNBs can be connected to each other through Xn interface, and will be connected to various core network elements like an AMF (Access and Mobility Management Function), a UPF (User Plane Function) etc. Further, the gNBs can be divided into two physical entities named CU (Centralized Unit) and DU (Distributed Unit). The CU provides support for the higher layers of the protocol stack such as a SDAP (Session Data Application Protocol), a PDCP (Packet Data Convergence Protocol) and the RRC while the DU provides support for the lower layers of the protocol stack such as a RLC (Radio Link Control), a MAC (Medium Access Control) and a Physical layer. Each gNB can have multiple cells serving many UEs. There are a large number of algorithms and configuration parameters used in the NG-RAN. Especially, it is a very difficult task to identify the most optimal radio parameters and operators used to resort to manual techniques like drive tests to identify the parameters. However, such manual parameter tuning is a costly operation since it depends on a lot of factors like the number of users, number of neighbors, maximum throughput in the cell, average throughput in the cell etc. Further, whenever a neighbor gNB is installed or a new service is introduced, many of these manual operations need to be repeated. To resolve this problem, the 3gpp has introduced a self-organizing networks (SON) techniques in the wireless technologies like NR. The SON was first introduced in the 3gpp release 9, in (Long-Term Evolution) LTE. The SON solutions can be divided into three categories: self-configuration, self-optimization and self-healing. The SON architecture can be a centralized, distributed or a hybrid solution.

The self-optimization of the RACH aims to minimize the number of attempts on the RACH. The UE can report the detailed information about the RACH in the RACH Report to the network and the network will optimize various parameters associated with the RACH using the information. A List of information that the UE could report in the RACH is given as below based on NR TS 38.331.

TABLE 3
RA-ReportList-r16 ::= SEQUENCE (SIZE (1..maxRAReport-r16)) OF RA-Report-r16

| | |
|---|---|
| RA-Report-r16 ::= | SEQUENCE { |
| cellId-r16 | CHOICE { |
| cellGlobalId-r16 | CGI-Info-Logging-r16, |
| pci-arfcn-r16 | SEQUENCE { |
| physCellId-r16 | PhysCellId, |
| carrierFreq-r16 | ARFCN-ValueNR |

```
        }
      },
```

| | | |
|---|---|---|
| ra-InformationCommon-r16 | RA-InformationCommon-r16 | OPTIONAL, |

| | |
|---|---|
| raPurpose-r16 | ENUMERATED {accessRelated, beamFailureRecovery, |

reconfigurationWithSync, ulUnSynchronized,

schedulingRequestFailure, noPUCCHResourceAvailable,

requestForOtherSI,

spare9, spare8, spare7, spare6, spare5, spare4, spare3,

```
  spare2, spare1},
      ... }
```

| | |
|---|---|
| RA-InformationCommon-r16 ::= | SEQUENCE { |
| absoluteFrequencyPointA-r16 | ARFCN-ValueNR, |
| locationAndBandwidth-r16 | INTEGER (0.37949), |
| subcarrierSpacing-r16 | SubcarrierSpacing, |

| | |
|---|---|
| msg1-FrequencyStart-r16 | INTEGER (0..maxNrofPhysicalResourceBlocks-1) |

OPTIONAL,

| | |
|---|---|
| msg1-FrequencyStartCFRA-r16 | INTEGER (0..maxNrofPhysicalResourceBlocks-1) |

OPTIONAL,

| | | |
|---|---|---|
| msg1-SubcarrierSpacing-r16 | SubcarrierSpacing | OPTIONAL, |
| msg1-SubcarrierSpacingCFRA-r16 | SubcarrierSpacing | OPTIONAL, |
| msg1-FDM-r16 | ENUMERATED {one, two, four, eight} | OPTIONAL, |

| | |
|---|---|
| msg1-FDMCFRA-r16 | ENUMERATED {one, two, four, eight} |

OPTIONAL,

| | |
|---|---|
| perRAInfoList-r16 | PerRAInfoList-r16, |

```
      ...,
      [[
```

| | | |
|---|---|---|
| perRAInfoListExt-v1660 | PerRAInfoListExt-v1660 | OPTIONAL |

```
            ]],
          [[
```

| | |
|---|---|
| msgA-FrequencyStart-r17 | INTEGER (0..maxNrofPhysicalResourceBlocks- |

1) OPTIONAL,

| msgA-FrequencyStartCFRA-r17 | | INTEGER |
|---|---|---|
| (0..maxNrofPhysicalResourceBlocks-1) | OPTIONAL, | |
| msgA-SubcarrierSpacing-r17 | SubcarrierSpacing | OPTIONAL, |

| | |
|---|---|
| msgA-SubcarrierSpacingCFRA-r17 | SubcarrierSpacing |

OPTIONAL,

| | |
|---|---|
| msgA-FDM-r17 | ENUMERATED {one, two, four, eight} |

OPTIONAL,

| | |
|---|---|
| msgA-FDMCFRA-r17 | ENUMERATED {one, two, four, eight} |

OPTIONAL,

| | | |
|---|---|---|
| measuredDL-RSRP-r17 | RSRP-Range | OPTIONAL, |

| | |
|---|---|
| msgA-TransMax-r17 | ENUMERATED {n1, n2, n4, n6, n8, n10, n20, |

n50, n100, n200} OPTIONAL

| | | |
|---|---|---|
| msgA-MCS-r17 | INTEGER (0..15) | OPTIONAL, |
| nrofPRBs-PerMsgA-PO-r17 | INTEGER (1..32) | OPTIONAL, |

| | |
|---|---|
| msgA-PUSCH-TimeDomainAllocation-r17 | INTEGER (1..maxNrofUL-Allocations) |

OPTIONAL,

| | |
|---|---|
| frequencyStartMsgA-PUSCH-r17 | INTEGER (0..maxNrofPhysicalResourceBlocks- |

1) OPTIONAL,

| | |
|---|---|
| nrofMsgA-PO-FDM-r17 | ENUMERATED {one, two, four, eight} |

OPTIONAL,

| | | |
|---|---|---|
| dlPathlossRSRP-r17 | RSRP-Range | OPTIONAL, |

| | |
|---|---|
| intendedSIBs-r17 | SEQUENCE (SIZE (1..maxSIB)) OF SIB-Type-r17 |

OPTIONAL,

| | |
|---|---|
| ssbsForSI-Acquisition-r17 | SEQUENCE (SIZE (1..maxNrofSSBs-r16)) OF SSB- |

Index OPTIONAL,

| | | |
|---|---|---|
| msgA-PUSCH-PayloadSize-r17 | BIT STRING (SIZE (3)) | OPTIONAL, |
| onDemandSISuccess-r17 | BOOLEAN | OPTIONAL |

]] }
PerRAInfoList-r16 ::= SEQUENCE (SIZE (1..200)) OF PerRAInfo-r16
PerRAInfoListExt-v1660 ::= SEQUENCE (SIZE (1..200)) OF PerRACSI-RSInfoExt-v1660

| | |
|---|---|
| PerRAInfo-r16 ::= | CHOICE { |
| perRASSBInfoList-r16 | PerRASSBInfo-r16, |
| perRACSI-RSInfoList-r16 | PerRACSI-RSInfo-r16 |

}

| | |
|---|---|
| PerRASSBInfo-r16 ::= | SEQUENCE { |
| ssb-Index-r16 | SSB-Index, |
| numberOfPreamblesSentOnSSB-r16 | INTEGER (1..200), |
| perRAAttemptInfoList-r16 | PerRAAttemptInfoList-r16 |

}

| | |
|---|---|
| PerRACSI-RSInfo-r16 ::= | SEQUENCE { |
| csi-RS-Index-r16 | CSI-RS-Index, |
| numberOfPreamblesSentOnCSI-RS-r16 | INTEGER (1..200) |

}

| PerRACSI-RSInfoExt-v1660 ::= | SEQUENCE { | |
|---|---|---|
| csi-RS-Index-v1660 | INTEGER (1..96) | OPTIONAL |

}

| | |
|---|---|
| PerRAAttemptInfoList-r16 ::= | SEQUENCE (SIZE (1..200)) OF PerRAAttemptInfo- |

r16

| PerRAAttemptInfo-r16 ::= | SEQUENCE { | |
|---|---|---|
| contentionDetected-r16 | BOOLEAN | OPTIONAL, |
| dlRSRPAboveThreshold-r16 | BOOLEAN | OPTIONAL, |

...,
[[

| | | |
|---|---|---|
| fallbackRAR-Received-r17 | BOOLEAN | OPTIONAL |

]] }

The UE sends the RACH reports to the network in the RRC messages, for e.g. the UE Information Response. On receiving the RACH report, the gNB CU may send it to the gNB DU or OAM (Operations, administration, and management) SON module or may directly use it for optimizing various parameters related to the RA. For e.g. the number of preambles, configuration of group A and group B preambles, the RACH prioritization information, the contention resolution timer, number of RACH preambles for the 2 step RACH and the PUSCH related parameters for 2 step RACH etc.

The 3gpp has discussed the optimization of the RACH for feature specific RA and has decided that the UE can send the feature or the combination of features that triggered the RACH as well as the used feature combination to the gNB for self-optimization purposes. The UE also include Network Slice AS Group (NSAG) ID when the applicable feature is slicing.

Thus, it is desired to address the above-mentioned disadvantages or other shortcomings or at least provide a useful alternative.

Accordingly, the embodiments disclose method for optimizing a RA of a UE in a wireless communication network system. When the UE experiences a LBT mechanism failure, the UE performs remaining repetitions using a same RA (Random access) resources and does not perform the RA resource selection procedure.

In an embodiment, the UE skips the remaining repetitions and performs the RA resource selection procedure, when the LBT failure recovery configuration is configured. The UE skips remaining repetitions and increments a preamble transmission counter, when the LBT failure recovery configuration is not configured.

In an embodiment, when the UE experiences the LBT failures during a msg1 repetitions, the UE performs the same number of repetitions using the same RA resources. The UE may retransmit the preamble for which the LBT failure occurred.

In an embodiment, when the UE which is configured to perform a N repetition due to the msg1 repetitions, and experiences the LBT failure for a M RA preamble transmission in a RA attempt, performs a M-N repetitions of the preamble transmissions. Here, N, M are a specific number of repetitions.

In an embodiment herein is to provide that the remaining repetitions are performed by the UE for a CBRA and not performed for a CFRA.

In an embodiment herein is to provide the method for self s optimization (including optimizations for minimization of drive tests) of the RA in the wireless communication networks like a 5G NR and the methods of sending the RA information to a network apparatus by the UE in a NR.

Accordingly in another embodiment herein, when the UE experiences the LBT failures during the msg1 repetitions, the UE performs the remaining repetitions. In an embodiment, the UE experiences the LBT failures during the msg1 repetitions, the UE performs the remaining repetitions using the same RA resources (i.e. the UE doesn't perform the RA resources selection procedure).

In another embodiment, if the UE experiences the LBT failures during the msg1 repetitions, the UE performs the remaining repetitions using the same RA resources (i.e. the UE doesn't perform the RA resources selection procedure) and also doesn't increment the preamble transmission counter (PREAMBLE_TRANSMISSION_COUNTER as in MAC specifications like NR TS 38.321).

In another embodiment, if the UE which is configured to perform the N repetitions due to the msg1 repetitions, and experiences the LBT failure for the M random access preamble transmissions, in the RA attempt, performs M-N repetitions of preamble transmissions.

In another alternate embodiment, if the UE experiences the LBT failures during the msg1 repetitions, the UE skips the remaining repetitions. In an embodiment, in such a scenario the UE may perform the RA resource selection procedure, if a lbt-FailureRecoveryConfig is configured.

In another alternate embodiment, if the UE experiences the LBT failures during the msg1 repetitions, the UE skips the remaining repetitions and increments the preamble transmission counter (PREAMBLE_TRANSMISSION_COUNTER as in MAC specifications like the NR TS 38.321). In an embodiment, the above scenario is applied if the LBT failure recovery configuration (such as lbt-FailureRecovery) is not configured.

In another embodiment, if the UE experiences the LBT failures during the msg1 repetitions, the UE performs the same number of repetitions. The UE may retransmit the preamble for which the LBT failure occurred.

In an embodiment, if the UE experiences the LBT failures during the msg1 repetitions, further the UE performs the same number of repetitions using the same RA resources (i.e. the UE doesn't perform RA resources selection procedure). In an embodiment, this may be performed if the msg1 repetitions is for the CBRA and not performed if the msg1 repetition is for the CFRA.

In an embodiment, the UE which is capable of reporting the enhancements for a SON/Minimization of drive tests (MDT) of the msg1 repetitions informs a network apparatus that it is capable of reporting the enhancements for the SON/MDT of the msg1 repetitions (the UE is capable of storing and reporting the information related to msg1 repetitions).

In an embodiment, the network apparatus may inform the UE to log the msg1 repetitions related information. The UE which is capable for the msg1 repetitions and is capable for a RA reporting, aRLF Reporting, a CEF Reporting, a SHR reporting and a SPR reporting is capable for reporting enhancements for the msg1 repetitions.

In an embodiment, the UE which has performed msg1 repetitions for the RA procedure logs and reports to the network apparatus that it has performed msg1 repetitions for this RA procedure. In the NR, the msg1 repetitions are logged in a RA_InformationCommon (such as RA_InformationCommon structure in NR TS 38.331).

In an embodiment, in the NR, the msg1 repetitions are logged and reported in the RA Report, RLF report and CEF report. The UE may also report the number of the msg1 repetitions (the number of preamble transmissions) for the RA procedure.

In an embodiment, the UE logs that the RA is triggered due to a feature msg1 repetitions or that the msg1 repetitions is one of the features that triggered the RA (for e.g. a TriggeredFeatureCombination IE in the RA-InformationCommon may include the msg1 repetitions or the msg1 repetitions with specific number of attempts).

In an embodiment, the UE may log that the RA is triggered due to the feature msg1 repetitions with the specific number of repetitions or that msg1 repetitions with the specific number of repetitions is one of the features that triggered the RA.

In an embodiment, the UE may log that the resources or the parameters for the RA were selected using the feature msg1 repetitions or that the msg1 repetitions is one of the features that is used for selecting the RA resources (for e.g. in the NR, a SelectedFeatureCombination IE or a UsedFeatureCombination IE in the RA-InformationCommon may include the msg1 repetitions or msg1 repetitions for the specific number of repetitions).

In an embodiment, the UE may log that the RA is triggered due to the feature msg1 repetitions with the specific number of repetitions or that the msg1 repetitions with the specific number of repetitions is one of the features that triggered the RA (for e.g. in the NR TriggeredFeatureCombination IE in the RA-InformationCommon may include the msg1 repetitions or msg1 repetitions for the specific number of repetitions).

In an embodiment, the UE which has performed the msg1 repetitions for the RA attempt logs and reports to the network apparatus that it has performed the msg1 repetitions for this RA attempt. The UE also report the number of the msg1 repetitions (the number of preamble transmissions) for this RA attempt. In the NR, this may be logged in the RA_InformationCommon. In an embodiment, this may be included in a PerRAAttemptInfo-r16 in the NR. All the preamble transmissions for the msg1 repetitions are considered as part of a single RA attempt. In the NR, this may be logged and reported in the RA Report, the RLF report and the CEF report.

In an embodiment, the UE which has performed the msg1 repetitions for the RA transmission on a Tx (transmission) beam logs and reports to the network apparatus that it has performed the msg1 repetitions for this beam. The UE may also report the number of the msg1 repetitions (the number of the preamble transmissions) for this beam in the RA procedure. In the NR, this may be logged in the RA_InformationCommon. In NR, this may be logged and reported in the RA Report, the RLF report and the CEF report.

In an embodiment, the UE may log and report the number of the msg1 repetitions configured by the network apparatus, the number of msg1 repetitions selected by the UE and the number of msg1 repetitions performed by the UE.

In an embodiment, the UE may log a DLRSRP at the time of selection of the number of the msg1 repetitions to be performed. The DL RSRP logged and reported would be the measured RSRP of the DL pathloss reference obtained at the time of selection of the number of the msg1 repetitions. In an embodiment, the UE reports a IE dlRSRPAboveThreshold based on the dIRSRPAboveThreshold associated with the selected number of the msg1 repetitions.

In an embodiment, for a 4 step RA procedure with the msg1 repetitions, the dIRSRPAboveThreshold is used to indicate whether a DL beam Synchronization Signal Block (SSB) quality associated to the RA attempt was above or below the threshold configured for selecting the msg1 repetitions. If the DL beam (SSB) quality associated to the RA attempt was above the threshold configured for selecting the msg1 repetitions, the UE sets the field dIRSRPAboveThreshold as true, otherwise the UE sets this field as false.

In an embodiment, for the 4 step RA procedure with the msg1 repetitions, the dIRSRPAboveThreshold is used to indicate whether the DL beam (SSB) quality (RSRP) associated to the RA attempt was above or below the smallest threshold configured for selecting the msg1 repetitions (For e.g. If there are three thresholds configured, one each for 2 repetitions, 4 repetitions, 8 repetitions, the dlRSRPAboveThreshold indicates if the measured RSRP is less than the smallest threshold among these).

In an embodiment, if the DL beam (SSB) quality (RSRP) associated to the RA attempt was above the smallest threshold configured for selecting the msg1 repetitions, the UE sets the field dlRSRPAboveThreshold as true, otherwise the UE sets this field as false.

In an embodiment, for the 4-step RAprocedure with the msg1 repetitions, the dIRSRPAboveThreshold is used to indicate whether the DL beam (SSB) quality associated to the RAattempt was above or below the largest threshold configured for selecting the msg1 repetitions. (For e.g. If there are three thresholds configured, one each for the 2 repetitions, the 4 repetitions, the 8 repetitions, the dIRSRPAboveThreshold indicates if the measured RSRP is less than the largest threshold among these). If the DL beam (SSB) quality associated to the RA attempt was above the largest threshold configured for selecting the msg1 repetitions, the UE sets the field dIRSRPAboveThreshold as true, otherwise the UE sets this field as false.

In an embodiment, for the 4 step RA procedure with msg1 repetitions, the UE logs and reports the (RSRP) threshold which is satisfied for selecting the number of msg1 repetitions to the network apparatus.

In an embodiment, the UE logs and reports the RSRP value corresponding to this threshold. The UE logs and reports the index of the threshold in the list of thresholds configured by the network apparatus. The threshold reported may be a RSRQ threshold.

In an embodiment, all the above information is logged and reported per RA procedure.

In an alternate embodiment they are logged per RA attempt.

In yet another embodiment, they are logged per beam.

In an embodiment, while reporting the number of the preambles transmitted on a SSB for the RA procedure with the msg1 repetitions, the UE considers all the repetitions in the single RA attempt as the single preamble transmission. For e.g. if the UE has made two RA attempts and transmitted 8 preambles and 4 preambles respectively for these attempts, the UE reports that there are only 2 preamble transmissions (In an example embodiment, this may be communicated in a numberOfPreamblesSentOnSSB-r16 IE in the NR) In an embodiment, while reporting the number of preambles transmitted on the SSB for the RA procedure with the msg1 repetitions, the UE considers all the repetitions in the single RA attempt as separate preamble transmissions. For e.g. if the UE has made the two RA attempts and transmitted the 8 preambles and the 4 preambles respectively for these attempts, the UE reports that there are only 12 preamble transmissions. (In an example embodiment, this may be communicated in the numberOfPreamblesSentOnSSB-r16 IE in the NR).

In an embodiment, the UE logs and reports if it has performed msg3 repetitions while the msg1 repetitions are performed. The UE logs and reports if it has performed msg3 repetitions while the conditions for the msg1 repetitions are satisfied.

In an embodiment, on receiving a RRC message including the details of the feature specific RA resource selection, a gNB RRC in a gNB CU (Central unit) may forward it to a gNB DU (distributed unit) and to the SON module, for e.g. OAM. SON module in CU/DU or SON module outside the gNB can identify if the number of resources allocated for a particular feature or a particular scenario within the feature (for e.g. resources for a particular NSAG) is optimum based on the received information. Further, the resources allocated per feature or per NSAG could be increased or decreased based on the received information. The Self-optimization module in the network apparatus may also adapt the criteria for using the feature specific RA resources and other RACH parameters based on the received information from the UE.

An example of some of the parameters which may be optimized based on the methods specified are given below.

Setting the RSRP thresholds for the MSG1 repetitions Deciding the UL coverage of ta cell.

The SSB selection related parameters, i.e., rsrp-ThresholdSSB, msgA-RSRP-ThresholdSSB.

Power control related parameters, i.e., preambleReceivedTargetPower/gA-PreambleReceivedTargetPower, powerRampingStep/msgA-PreamblePowerRampi ngStep, msg3-DeltaPreamble/msgA-DeltaPreamble.

Preamble group related parameters, i.e., msg3-DeltaPreamble/msgA-DeltaPreamble, messagePowerOffsetGroupB for 2-step RA and 4-step RA.

Accordingly, the embodiments disclose method for optimizing the RA of the UE in the wireless communication network system. The method includes performing, by the UE, the RA with the network apparatus associated with the UE by applying the msg1 repetitions. Further, the method includes storing, by the UE, RA-information in a memory of the UE. The RA-information comprises a plurality of resources indicating the RA is triggered by msg1 repetitions or the RA has used the msg1 repetitions (i.e. the resources configured for msg1 repetitions). Further, the method includes transmitting, by the UE, the stored RA-information to the network apparatus for optimizing the RA for the UE.

Accordingly, the embodiment herein is to provide the UE for optimizing the RA of the UE in the wireless communication network system. The UE comprising the memory, a processor, a communicator, and an msg1 repetitions controller. The msg1 repetitions controller is connected to the memory and the processor. The msg1 repetitions controller performs the RA with the network apparatus associated with the UE by applying msg1 repetitions. Further the method stores RA-information in the memory of the UE. The RA-information comprises the plurality of resources indicating the RA triggered by the msg1 repetitions or the RA has used the msg1 repetitions. Further the method transmits the stored RA-information to the network apparatus for optimizing the RA for the UE.

Accordingly, the embodiment herein is to provide the network apparatus for optimizing the RA of the UE in the wireless communication network system. The network apparatus includes a memory, a processor, a communicator and a msg1 repetitions controller. The msg1 repetitions controller transmits an information request message to the UE. Further msg1 repetitions controller receives an information response message from the UE. The information response message comprises RA-information stored by the UE. The RA-information comprises the plurality of resources indicating one of the RA triggered by the msg1 repetitions or the RA has used the msg1 repetitions and optimize the plurality of resources based on the RA-information.

Problems related to coverage enhancements of the NR networks, self-optimization in the NR. As each gNB can have multiple cells serving many UEs. Also, there are a large number of algorithms and configuration parameters used in the NG-RAN resulting to be a very difficult task to identify the most optimal radio parameters and operators used to resort to manual techniques like drive tests to identify the parameters. Thus, it is desired to address the above-mentioned disadvantages or other shortcomings or at least provide a useful alternative. Hence, our solution addresses all the below problems like how to perform the SON/MDT of the RA performed for msg1 repetitions. When the RA configuration or the RA resources is applied based on the resources configured for msg1 repetitions or multiple features where msg1 repetitions is one of the features, how to perform SON/MDT of RA.

The disclosure offers an elegant approach, comprising a method for optimizing the RA of the UE in the wireless communication network system. Further the solution is to provide a method for the UE to perform, when the UE experiences the LBT mechanism failure. Further the solution is to provide that the UE performs remaining repetitions using the same RA resources and does not perform RA resource selection procedure. Further the solution includes is to provide that the UE skips remaining repetitions and increments the preamble transmission counter.

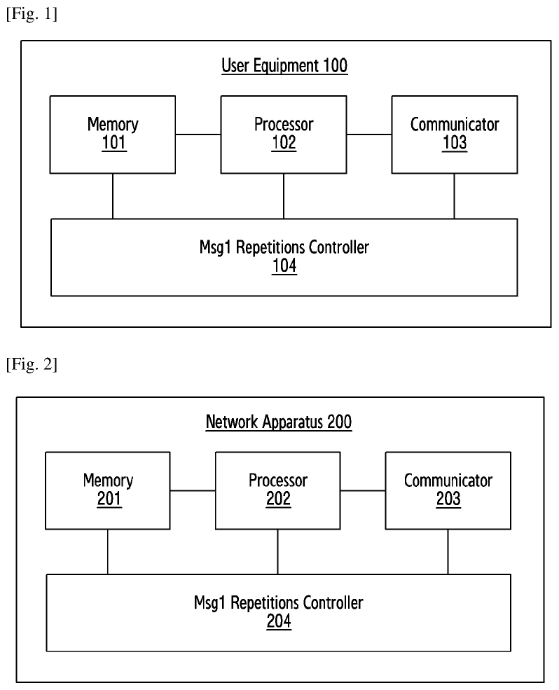

FIG. 1 illustrates a block diagram of the UE (100) that illustrates various hardware components used for optimizing the RA in the wireless communication network system, according to the embodiments disclosed herein. The UE (100) includes the processor (102), the memory (101), the communicator (103), and the Msg1 Repetitions Controller (104).

In an embodiment, the UE (100) acts as an end-user device are capable of connecting to the wireless communication network system for the purpose of accessing services. This device can take various forms, including but not limited to a mobile phone, a smart phone, tablets, laptops, and Internet of Things (IoT) devices. Essentially, any device that can connect to the wireless communication network system and access services can be considered the UE (100).

Further, the processor (102) communicates with the memory (101), the communicator (103), the msg1 Repetitions Controller (104). The processor (102) can include one or a plurality of processors, can be a general-purpose processor, such as a central processing unit (CPU), an application processor (AP), or the like, a graphics-only processing unit such as a graphics processing unit (GPU), a visual processing unit (VPU), and/or an Artificial intelligence (AI) dedicated processor such as a neural processing unit (NPU).

Further, the memory (101) of the UE (100) includes storage locations to be addressable through the processor (102). The memory (101) is not limited to a volatile memory and/or a non-volatile memory. Further, the memory (101) can include one or more computer-readable storage media. The memory (101) can include non-volatile storage elements. For example, non-volatile storage elements can include magnetic hard discs, optical discs, floppy discs, flash memories, or forms of electrically programmable memories (EPROM).

The communicator (103) serves as the intermediary for transmitting information between the memory (101) and external peripheral devices, which are the input-output devices associated with the UE (100). This communicator (103) not only receives multiple information from the network, but also possesses additional resources such as voltage translators, registers, impedances, and buffers. For instance, input devices such as a keyboard and mouse provide data to the computer, while output devices such as a monitor and printer display and print information.

In an embodiment, the msg1 repetitions controller (104) is an innovative hardware that is implemented through the physical implementation of both analog and digital circuits, including logic gates, integrated circuits, microprocessors, microcontrollers, memory circuits, passive and active electronic components, as well as optical components.

In an embodiment, the msg1 repetition controller (104) is connected to the memory (101) and the processor (102). The msg1 repetitions Controller (104) performs the RA with the network apparatus associated with the UE (100) by applying message one (msg1) repetitions. Further, the method stores RA-information in a memory of the UE (100). The RA-information comprises a plurality of resources indicating the RA triggered by the msg1 repetitions or the RA has used the msg1 repetitions. Further the method transmits the stored RA-information to the network apparatus (200) for optimizing the RA for the UE (100).

In an embodiment, the plurality of resources comprises an information that the random access is triggered due to feature msg1 repetitions or that msg1 repetition is one of the features that triggered random access.

In an embodiment, the plurality of resources comprises an information that the resources or the parameters for random access were selected using the feature msg1 repetitions or that the msg1 repetitions is one of the features that is used for selecting the RA resources.

In an embodiment, the plurality of resources comprises at least one the msg1 repetitions are performed, a number of msg1 repetitions performed, a RSRP threshold used for selecting the number of msg1 repetitions, a DLRSRP above or below a msg1 repetitions threshold, a triggered feature combination including the msg1 repetitions, a feature combination including the msg1 repetitions, a number of the msg1 repetitions configured by the network, and a beam related information for the msg1 repetitions.

In an embodiment, to transmit, the stored RA-information to the network apparatus (200) for optimizing the RA includes receiving an information response message comprising the RA-information stored by the UE (100). Further, the method includes creating an information response message comprising the RA-information stores by the UE (100). Further, the method includes transmitting the information response message comprising the RA-information to the network apparatus (200) for optimizing the RA for the UE (100).

In an embodiment, the information request message comprises an indication of at least one of a connection failure report request, a RA-report request, an RLF-report request, a CEF-report request, a SHR request message and a SPR request, and wherein the information response message comprises a connection failure report, a RA-report, a RLF report, a CEF report, a SHR and a SPR.

FIG. 2 illustrates a block diagram of a network apparatus (200) that illustrates various hardware components for optimizing the RA in the wireless communication network system, according to the embodiments disclosed herein.

In an embodiment, the network apparatus not limited to a laptop, a palmtop, a desktop, a mobile phone, a smart phone, Personal Digital Assistant (PDA), a tablet, a wearable device, an Internet of Things (IoT) device, a virtual reality device, a foldable device, a flexible device, a display device and an immersive system. In an embodiment, a network apparatus (200) includes the memory (201), a processor (202), a communicator (203), and a msg1 repetition controller (204).

The msg1 repetitions controller (204) is connected to the memory (201) and the processor (202). In an embodiment, the processor (202) communicates with the memory (201), the communicator (203), the Msg1 Repetition Controller (204). The processor (202) can include one or a plurality of processors, can be a general-purpose processor, such as a central processing unit (CPU), an application processor (AP), or the like, a graphics-only processing unit such as a graphics processing unit (GPU), a visual processing unit (VPU), and/or an Artificial intelligence (AI) dedicated processor such as a neural processing unit (NPU).

In an embodiment, the memory (201) includes storage locations to be addressable through the processor (202). The memory (201) is not limited to a volatile memory (201) and/or a non-volatile memory (201). Further, the memory (201) can include one or more computer-readable storage media. The memory (201) can include non-volatile storage elements. For example, non-volatile storage elements can include magnetic hard discs, optical discs, floppy discs, flash memories, or forms of electrically programmable memories (EPROM) or electrically erasable and programmable (EEPROM) memories.

In an embodiment, the communicator (203) serves as the intermediary for transmitting information between the memory (201) and external peripheral devices, which are the input-output devices associated with the UE (100). This communicator (203) not only receives multiple information from the network, but also possesses additional resources such as voltage translators, registers, impedances, and buffers. For instance, input devices such as a keyboard and mouse provide data to the computer, while output devices such as a monitor and printer display and print information respectively.

In an embodiment, the msg1 repetitions controller (204) is an innovative hardware that is implemented through the physical implementation of both analog and digital circuits, including logic gates, integrated circuits, microprocessors, microcontrollers, memory circuits, passive and active electronic components, as well as optical components.

In an embodiment, the msg1 repetitions controller (204) transmits an information request message to the UE (100). Further msg1 repetitions controller (204) receives an information response message from the UE (100). The information response message comprises RA-information stored by the UE (100). The RA-information comprises a plurality of resources indicating one of the RA triggered by the msg1 repetitions or the RA has used the msg1 repetitions and optimize the polarity of resources based on the RA-information.

In an embodiment, to optimize the plurality of resources based on the RA-information includes determining whether a number of resources allocated to perform a specific feature is optimum based on the RA-information. Further the method includes modifying the number of resources allocated to perform the specific feature based on the RA-information when the number of resources allocated to perform the specific feature is not optimum.

In an embodiment, resources include configuration of number of msg1 repetitions, random access preambles, random access occasions, configurations for power control and the number of repetitions of RACH procedure.

In an embodiment, the plurality of resources comprises at least one the msg1 repetitions are performed, a number of msg1 repetitions performed, a RSRP threshold used for selecting the number of msg1 repetitions, a DLRSRP above or below a msg1 repetition threshold, a triggered feature combination including the msg1 repetitions, a feature combination including the msg1 repetitions, a number of the msg1 repetitions configured by the network, and a beam related information for the msg1 repetitions.

In an embodiment, the information request message comprises indication of at least one of a connection failure report request, a RA-report request, an RLF-report request, a CEF-report request, and a SHR report request, and wherein the information response message comprises a connection failure report, a RA-report, a RLF report, a CEF report, and a SHR report.

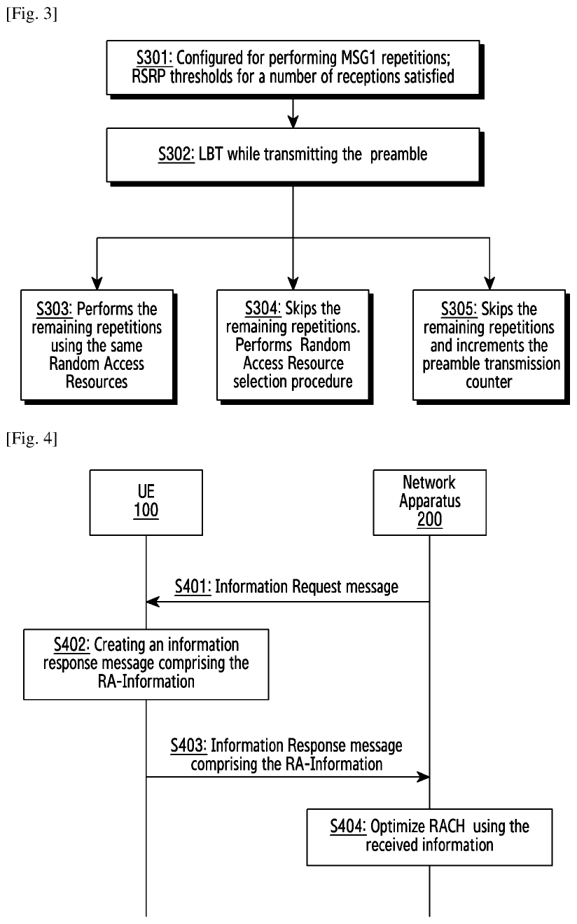

FIG. 3 is a flow chart that illustrates a method for LBT and msg1 1 repetitions, according to the embodiments as disclosed herein.

In an embodiment, at step S301, the UE (100) is configured for performing msg1 repetitions and log the DL RSRP value at the time of selection of the number of msg1 repetitions to be performed. The UE (100) logs and reports the threshold which is satisfied for selecting the number of msg1 repetitions to the network apparatus (200), the RSRP value corresponding to thresholds for a number of receptions satisfied.

In an embodiment, the UE (100) also report the number of msg1 repetitions (the number of preamble transmissions) for the RA procedure. The UE (100) may log that the random access is triggered due to feature msg1 repetition or that msg1 repetition is one of the features that triggered random access. Further, at step S302, the LBT is performed while transmitting the preamble.

In an embodiment, based on the UE (100) experiences Listen-Before-Talk (LBT) mechanism failure, the UE (100).

In an embodiment, at step S303, the UE (100) performs one of remaining reception of the msg1 using the same RA Resource, at step S304, skips the remaining reception of the msg1 and when LBT failure recovery configuration is configured, performs the RA resource selection process, or at step S304, skips the remaining reception of the msg1 and when LBT failure recovery configuration is not configured, increments the preamble transmission counter.

FIG. 4 is a sequence diagram that illustrates reporting msg1 repetitions information to the network apparatus (200), according to the embodiments as disclosed herein.

In an embodiment at S401, the Network Apparatus (200) sends the information requested by the UE (100) with at least one of connection fail report request, RA-report request, RLF-report request, or any similar report request, set to true. Further at S402, the UE (100) includes msg1 repetitions related information for SON, creating an information response message comprising the RA-Information and at S403, transmits the UE (100) information response including the msg1 repetition related information to the Network apparatus (200). Further, at S404, based on the received repetition related information the network apparatus (200) optimizes RACH using the received information.

FIG. 5 is a flow chart that illustrates a method implemented by the network apparatus (200) for optimizing the RA in the wireless communication network system, according to the embodiments as disclosed herein.

In an embodiment, at S501, transmitting, by a network apparatus (200), an information request message to the UE (100). Further, at S502, the method includes receiving, by the network apparatus (200), an information response message from the UE (100). The information response message comprises RA-information stored by the UE (100), and the RA-information comprises a plurality of resources indicating one of the RA triggered by the msg1 repetitions performed, a Received signal Received Power (RSRP) threshold used for selecting the number of msg1 repetitions, a Downlink Received signal Received Power (DLRSRP) above or below a msg1 repletion threshold, a triggered feature combination including the msg1 repetitions, a used feature combination including the msg1 repetitions, a number of the msg1 repetitions configured by the network apparatus (200), and a beam related information
for the msg1 repetitions or the RA has used the msg1 repetitions. At S503, the method includes receiving by the network apparatus, the stored information in RLF report, CEF report, SHR, RA report, SPR. Further at S504, the method includes optimizing, by the network apparatus (200), the plurality of resources based on the RA-information.

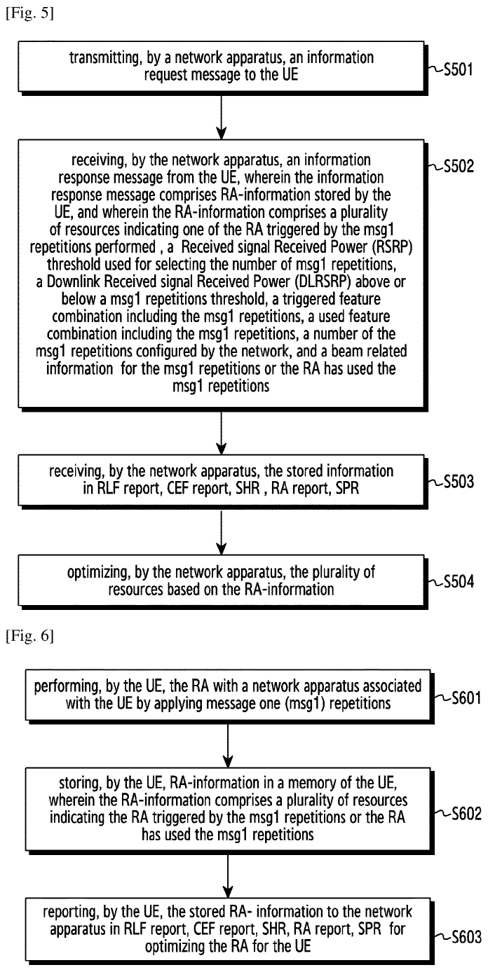

FIG. 6 is a flow chart that illustrates a method implemented by the UE (100) for storing, reporting and optimizing the RA of in the wireless communication network system, according to embodiments disclosed herein.

At S601, the method includes performing, by the UE (100), the RA with a network apparatus (200) associated with the UE (100) by applying message one (msg1) repetitions. At S602, the method includes storing, by the UE (100), RA-information in the memory (101) of the UE (100), wherein the RA-information comprises a plurality of resources indicating the RA triggered by the msg1 repetitions or the RA has used the msg1 repetitions. At S603, the method includes, reporting, by the UE (100), the stored RA-information to the network apparatus (200) in RLF report, CEF report, SHR, RA report, SPR for optimizing the RA for the UE (100).

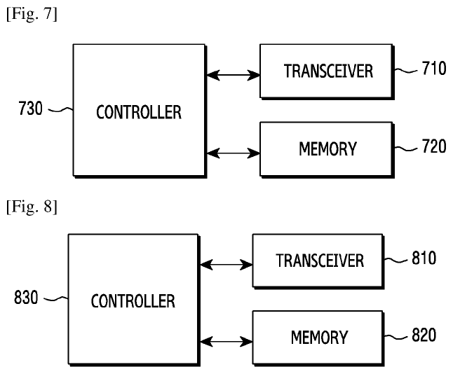

FIG. 7 illustrates a block diagram of a user equipment (UE) that illustrates various hardware components.

As shown in FIG. 7, the UE according to an embodiment may include a transceiver 710, a memory 720, and a processor 730. The transceiver 710, the memory 720, and the processor 730 of the UE may operate according to a communication method of the UE described above. However, the components of the UE are not limited thereto. For example, the UE may include more or fewer components than those described above. In addition, the processor 730, the transceiver 710, and the memory 720 may be implemented as a single chip. Also, the processor 730 may include at least one processor. Furthermore, the UE of FIG. 7 corresponds to the UE of the FIG. 1.

The transceiver 710 collectively refers to a UE receiver and a UE transmitter, and may transmit/receive a signal to/from a base station or a network entity. The signal transmitted or received to or from the base station or a network entity may include control information and data. The transceiver 710 may include a RF transmitter for up-converting and amplifying a frequency of a transmitted signal, and a RF receiver for amplifying low-noise and down-converting a frequency of a received signal. However, this is only an example of the transceiver 710 and components of the transceiver 710 are not limited to the RF transmitter and the RF receiver.

Also, the transceiver 710 may receive and output, to the processor 730, a signal through a wireless channel, and transmit a signal output from the processor 730 through the wireless channel.

The memory 720 may store a program and data required for operations of the UE. Also, the memory 720 may store control information or data included in a signal obtained by the UE. The memory 720 may be a storage medium, such as read-only memory (ROM), random access memory (RAM), a hard disk, a CD-ROM, and a DVD, or a combination of storage media.

The processor 730 may control a series of processes such that the UE operates as described above. For example, the transceiver 710 may receive a data signal including a control signal transmitted by the base station or the network entity, and the processor 730 may determine a result of receiving the control signal and the data signal transmitted by the base station or the network entity.

FIG. 8 illustrates a block diagram of a network entity that illustrates various hardware components.

Referring to FIG. 8, the network entity includes a transceiver (810), a memory (820), and a processor (830). The transceiver (810), the memory (820), and the processor (830) of the network entity may operate according to a communication method of the network entity described above. However, the components of the network entity are not limited thereto. For example, the network entity may include fewer or a greater number of components than those described above. In addition, the processor (830), the transceiver (810), and the memory (820) may be implemented as a single chip. Also, the processor (830) may include at least one processor.

The network entity includes at least one entity of a core network. For example, the network entity includes a base station (BS), an Access and mobility management function (AMF), a session management function (SMF), a policy control function (PCF), a network repository function (NRF), a user plane function (UPF), a network slicing selection function (NSSF), an authentication server function (AUSF), a unified data management (UDM) and a network exposure function (NEF), but the network entity is not limited thereto, the network entity may correspond to a network apparatus of FIG. 2.

The transceiver (810) collectively refers to a network entity receiver and a network entity transmitter, and may transmit/receive a signal to/from a base station or a UE. The signal transmitted or received to or from the base station or the UE may include control information and data. In this regard, the transceiver (810) may include an RF transmitter for up-converting and amplifying a frequency of a transmitted signal, and an RF receiver for amplifying low-noise and down-converting a frequency of a received signal. However, this is only an example of the transceiver (810) and components of the transceiver (810) are not limited to the RF transmitter and the RF receiver.

The transceiver (810) may receive and output, to the processor (830), a signal through a wireless channel, and transmit a signal output from the processor (830) through the wireless channel.

The memory (820) may store a program and data required for operations of the network entity. Also, the memory (820) may store control information or data included in a signal obtained by the network entity. The memory (820) may be a storage medium, such as a ROM, a RAM, a hard disk, a CD-ROM, and a DVD, or a combination of storage media.

The processor (830) may control a series of processes such that the network entity operates as described above. For example, the transceiver (810) may receive a data signal including a control signal, and the processor (830) may determine a result of receiving the data signal.

The various actions, acts, blocks, steps, or the like in the method is performed in the order presented, in a different order or simultaneously. Further, in some embodiments, some of the actions, acts, blocks, steps, or the like are omitted, added, modified, skipped, or the like without departing from the scope of the proposed method.

The foregoing description of the specific embodiments will so fully reveal the general nature of the embodiments herein that others can, by applying current knowledge, readily modify and or adapt for various applications such specific embodiments without departing from the generic concept, and, therefore, such adaptations and modifications are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the scope of the embodiments as described herein.

1. A method performed by a user equipment (UE) in a wireless communication system, the method comprising:
receiving, from a base station (BS), a UE information request message; and
transmitting, to the BS, a UE information response message including an information on a random access (RA) procedure,
wherein the information on the RA procedure includes information indicating msg1 repetitions.

2. The method of claim 1,
wherein the information on the RA procedure further includes information on a feature triggered the RA procedure, and
wherein the information on the feature triggered the RA procedure includes the information indicating msg1 repetitions.

3. The method of claim 1,
wherein the information on the RA procedure further includes information on a feature associated to a RA resource used in the RA procedure.

4. The method of claim 3,
wherein the information on the feature associated to the RA resource used in the RA procedure includes the information indicating msg1 repetitions.

5. A method performed by a base station (BS) in a wireless communication system, the method comprising:
transmitting, to a user equipment (UE), a UE information request message; and
receiving, from the UE, a UE information response message including information on a random access (RA) procedure,
wherein the information on the RA procedure includes information indicating msg1 repetitions.

6. The method of claim 5,
wherein the information on the RA procedure further includes information on a feature triggered the RA procedure, and
wherein the information on the feature triggered the RA procedure includes the information indicating msg1 repetitions.

7. The method of claim 5,
wherein the information on the RA procedure further includes information on a feature associated to a RA resource used in the RA procedure.

8. The method of claim 7,
wherein the information on the feature associated to the RA resource used in the RA procedure includes information indicating msg1 repetitions.

9. A user equipment (UE) in a wireless communication system, the UE comprising:
a transceiver; and
a controller coupled with the transceiver and configured to:
receive, from a base station (BS), a UE information request message;
transmit, to the BS, a UE information response message including an information on a random access (RA) procedure, and
wherein the information on the RA procedure includes information indicating msg1 repetitions.

10. The UE of claim 9,
wherein the information on the RA procedure further includes information on a feature triggered the RA procedure, and
wherein the information on the feature triggered the RA procedure includes the information indicating msg1 repetitions.

11. The UE of claim 9,
wherein the information on the RA procedure further includes information on a feature associated to a RA resource used in the RA procedure.

12. The UE of claim 11,
wherein the information on the feature associated to RA resources used in the RA procedure includes the information indicating msg1 repetitions.

13. A base station (BS) in a wireless communication system, the BS comprising:
a transceiver; and
a controller coupled with the transceiver and configured to:
transmit, to a user equipment (UE), a UE information request message; and
receive, from the UE, a UE information response message including information on a random access (RA) procedure,
wherein the information on the RA procedure includes information indicating msg1 repetitions.

14. The BS of claim 13,
wherein the information on the RA procedure further includes information on a feature triggered the RA procedure, and
wherein the information on the feature triggered the RA procedure includes the information indicating msg1 repetitions.

15. The BS of claim 13,
wherein the information on the RA procedure further includes information on a feature associated to a RA resource used in the RA procedure, and
wherein the information on the feature associated to the RA resource used in the RA procedure includes the information indicating msg1 repetitions.
